(19) United States
(12) Patent Application Publication
(10) Pub. No.: US 2011/0025090 A1
(43) Pub. Date: Feb. 3, 2011

(54) RIGIDIFIED WINDOW SYSTEM

(75) Inventor: Richard LANGLAIS, Cacouna (CA)

Correspondence Address: MERCHANT & GOULD PC, P.O. BOX 2903, MINNEAPOLIS, MN, 55402-0903, US

(73) Assignee: PRELCO INC., Rivière-du-Loup (CA)

(21) Appl. No.: 12/849,237

(22) Filed: Aug. 3, 2010

(30) Foreign Application Priority Data
Aug. 3, 2009 (CA) 2,674,768

(51) Int. Cl. B60J 1/10

(52) U.S. Cl. 296/146.15

(57) ABSTRACT

A rigidified window system includes a window and at least one supporting brace. The at least one supporting brace is bonded to the surface of the window using an adhesive offering a predetermined elasticity to the bond. Moreover, the quantity, shape, width, length and height and material used to manufacture the at least one supporting brace are selected in order to allow a certain flexibility of said window and the at least one supporting brace. The elasticity of the bond and the flexibility of the window and the at least one supporting brace provide absorption of the forces created by an impact, the absorption being shared between the window, the bond and the at least one supporting brace.

This application claims benefit of Serial No. 2,674,768, filed Aug. 3, 2009 in Canada and which application is incorporated herein by reference. To the extent appropriate, a claim of priority is made to each of the above disclosed applications.

### FIELD OF THE INVENTION

The present invention relates to window rigidification. More particularly, it relates to a rigidified window system and a method for manufacturing the same.

### BACKGROUND OF THE INVENTION

Lateral windows of transport vehicles such as trains, subways or buses are connected to the chassis mechanically using various techniques. In addition, rubber seals are installed along the periphery of the windows to ensure that they are watertight, to protect the interior of the vehicle during adverse weather.

Such lateral windows found on transport vehicles must resist certain impacts without breaking, while remaining safely in place. A growing number of security agencies have established different impact and pressure resistance tests to which such window systems must be subjected.

In general, compositions of tempered or laminated glass of a sufficient thickness are used in order to resist such impacts or pressures. When the resistance of a glass is found to be insufficient during a resistance test, the thickness of the glass composition is usually increased in order to increase its resistance to future shocks. However, this increase in the thickness of the glass also increases the weight of the vehicle. For vehicles comprising many lateral windows, the additional weight can be very significant.

Another problem with typical window systems is that if the glass bends sufficiently under the force of an impact without breaking, the bending of the window can disrupt the contact between the glass and the rubber seal. When the contact between the window and the rubber seal is lost, even momentarily, water leakage can occur, which undermines the watertightness of the window system.

U.S. Pat. No. 6,408,592 (HOURANI) discloses a brace for protecting a window of a building during a high wind storm, wherein the brace is affixed to the window using double sided tape, while mentioning that the brace may alternatively be affixed to the window using epoxy or glue. HOURANI teaches the use of a single rigid member (preferably appearing at the window diagonal), in order to rigidify the window and prevent breakage. The aim of such brace is to prevent flexing of the window as much as possible, in order to prevent window breakage. Preferred embodiments of the invention disclosed in HOURANI propose to stabilize the brace in the window frame, using various means, in order to transfer the stress placed on the window by the wind forces directly to the window frame and ultimately the building structure, therefore producing as rigid a support as possible. In the field of impact resistant windows, rigidity is certainly important; however, there are advantages associated with maintaining a certain flexibility in the window and the added support, in order to distribute the absorption of the forces between both elements. Moreover, the teachings of HOURANI are not concerned with the added weight imparted on the window by the brace. This is understandable given the fact that HOURANI is directed to a solution for rigidifying windows that are located on the sides of a building. However, as previously mentioned, weight is a critical factor that must be considered when dealing with window systems for transport vehicles, where additional weight has a direct impact on the energy consumption of the resulting vehicle.

There is, therefore a need for a rigidified window system providing better resistance to impacts and pressures while maintaining a certain flexibility in both the window and the added support, without substantially increasing the thickness of the window, in order to minimize the additional weight of the vehicle supporting such a rigidified window system.

### SUMMARY OF THE INVENTION

In accordance with one aspect of the present invention, there is provided a rigidified window system comprising a window and at least one supporting brace. In the rigidified window system according to this aspect of the present invention, the at least one supporting brace is bonded to the surface of the window using an adhesive offering a predetermined elasticity to the bond. Moreover, the quantity, shape, width length, height and material used to manufacture the at least one supporting brace are selected in order to allow a predetermined flexibility of said window and said at least is one supporting brace.

The bonding of the support braces to the window surface increases the rigidity of the window without increasing its thickness. Consequently, the resulting window system is lighter than a window system with similar rigidity where the increase in the rigidity is produced by an increase in the thickness of the glass. The present window system therefore helps minimize the extra weight added to the vehicle supporting such a window system.

The increased rigidity also helps to maintain contact between the glass and rubber seals when the window is subjected to pressure due to a sudden impact, thereby improving the watertightness of the window system.

An important characteristic of the rigidified window system according to this aspect of the present invention is the design of the supporting braces, as well as the materials used in their manufacture and in the bond with the window surface. These design and materials are intended to allow extra forces to be absorbed by the window, the bond and the supporting braces by allowing a predetermined flexibility of the components when forces are applied to the window. In the case of impacts, for example, the window is instantly subjected to a great amount of stress. Without the flexibility of the bond and supporting members, there is a high risk of shearing of the window at the vicinity of the supporting braces. These resulting shears are highly undesirable as they weaken the window system by decreasing its resistance to future impacts.

In accordance with another aspect of the present invention, there is provided a method of manufacturing a rigidified window system comprising the steps of providing a window and bonding at least one supporting brace to its surface. According to this aspect of the invention, the at least one supporting brace is bonded to the surface of the window using an adhesive, which is selected and sized to offer a predetermined elasticity to the bond. Moreover, the quantity, shape, width, length, height and material used to manufacture the at least one supporting brace are selected in order to allow a predetermined flexibility of the window and the at least one supporting brace. Once again, the elasticity of the bond and the flexibility of the window and the at least one supporting brace provide absorption of the forces created by an impact, and the absorption is shared between the window, the bond and the at least one supporting brace.

Other features and advantages of the present invention will be better understood upon a reading of the preferred embodiments thereof, with reference to the appended drawings.

### BRIEF DESCRIPTION OF THE DRAWINGS

For a better understanding of the invention, and to show how the same may be carried out, reference is now made by way of example to the accompanying drawings in which:

FIG. 1 shows an alternative embodiment of a rigidified window system comprising two supporting braces bonded on its surface.

FIG. 2 illustrates various possible variants of supporting braces that may be bonded to a window system to improve its rigidity.

### DESCRIPTION OF PREFERRED EMBODIMENTS

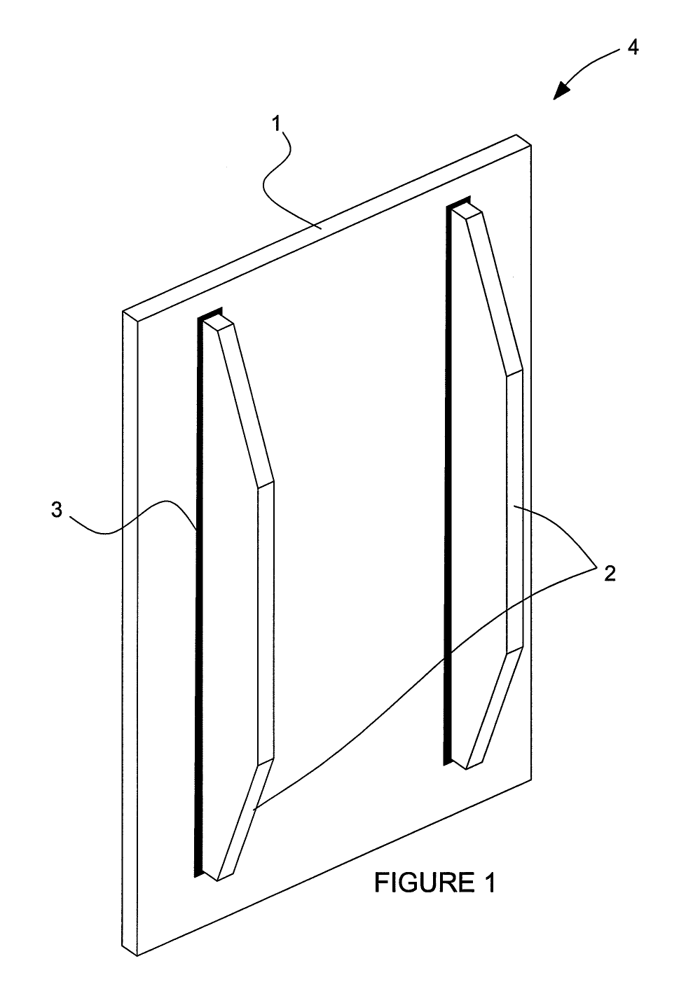

Referring to FIG. 1, in one aspect of the invention, there is provided a rigidified window system 4 where the rigidity of a window 1 is increased by the bonding of at least one supporting brace 2 to the surface of the window 1 using an adhesive 3.

Preferred embodiments of the invention are particularly adapted for window systems installed on transport vehicles, where impact resistance is a critical factor. One of the innovations of the present invention resides in the addition of at least one supporting brace 2 having specific properties to ensure a predetermined flexibility, and in the selection of the adhesive 3 used to bond each supporting brace 2 to the surface of the window 1 ensuring a predetermined elasticity to the bond. Thus, the composition of the window 1, and its thickness, need not be different than that of common windows usually used on transport vehicles. Common materials such as tempered glass, laminated glass, annealed glass, heat-strengthened glass or the like could be used in the manufacture of the window 1 used in the present rigidified window system 4. The thickness of the window will generally vary between 3 mm and 6 mm, which corresponds to the thickness of windows commonly used for transport vehicles.

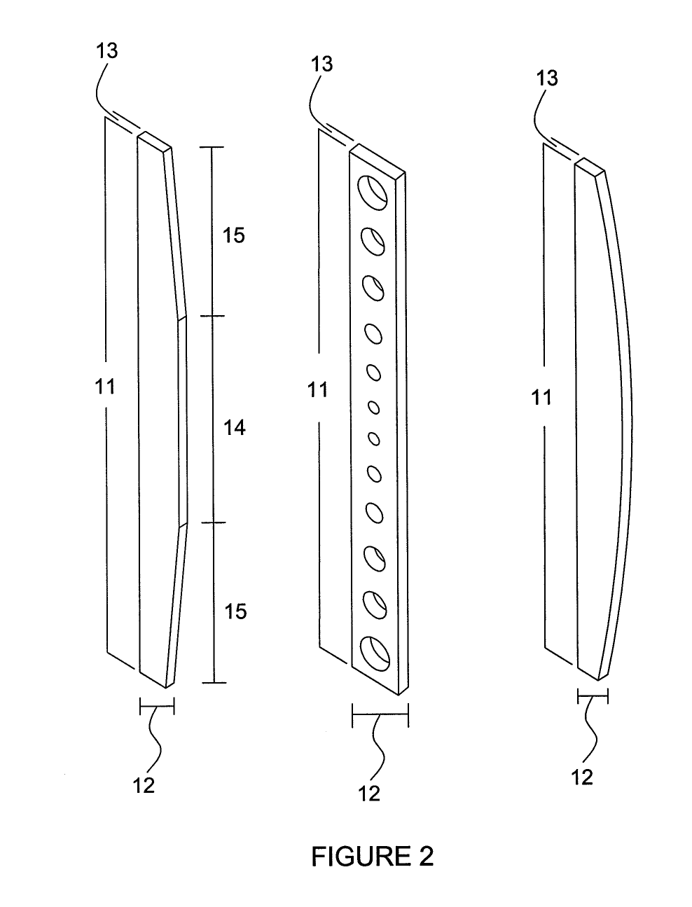

Now referring to FIGS. 1 and 2, the at least one supporting brace 2 that is part of the rigidified window system 4 must be designed carefully to ensure maximum impact resistance, while offering a predetermined flexibility in order to prevent shearing of the window 1 in the vicinity of the brace 2.

The above-mentioned predetermined flexibility must be selected in order to offer a certain flexibility to the window 2, adhesive bond 3 and supporting brace 2, without, however, exceeding the maximal stress level in the tension zone of the window created by the impact, in order to prevent window breakage.

The maximal stress level of a window varies in function of the bend radius corresponding to its deformation and the thickness of a window. It is represented by the mathematical equation:

σ=Et/2R

where σ: the maximal stress level;
E: Young modulus of the window;
t: the thickness of the window; and
R: the bend radius of the window.

Depending on the thermal treatment applied to the glass, this maximal stress level may be higher or lower. Typical values of maximal stress level for long term loads applied to a glass panel are:
Tempered glass: 29.5 N/mm²
Heat-strengthened glass: 17.4 N/mm²
Annealed glass: 9.7 N/mm²

These values can be increased in case of short term loads (loads of less than 60 seconds).

The first component to consider in the design of a supporting brace 2 is the material used in its manufacture. The selected material must be light, while offering high rigidity, in order to rigidify the window without significantly increasing its weight, but must also offer the above-mentioned predetermined flexibility. A supporting brace made of aluminum bears these characteristics and is preferably used, although other materials offering similar characteristics could also be used to manufacture the at least one supporting brace 1.

Other design inputs are the quantity, width 13, height 12, length 11 and shape of the at least one supporting brace 2. Quantity, width 13, height 12 and length 11 are variables that will vary greatly depending on the size of the window that must be rigidified, the desired increase in rigidity, and the maximum weight that may be added to the window system 4. There is therefore no general rule that can be established for these parameters, their valuation being highly dependant on the specifics of every case. As previously mentioned, while evaluating the proper value for the above-mentioned parameters (quantity, width 13, height 12 and length 11), one should be careful to ensure that the brace will respect the predetermined flexibility, in order to prevent shearing of the glass 1 in case of an impact.

Furthermore, still referring to FIGS. 1 and 2, the shape of the at least one supporting brace 2 must be considered. As shown in FIG. 2, different shapes may be contemplated, and one skilled in the art will readily understand that the possibilities for shapes of the at least one supporting brace 2 are not limited to the shapes hereby presented. Previous tests have demonstrated that, preferably, the brace 2 used in the present rigidified window system 4 has a shape similar to the brace presented at FIG. 1 (which is the same as the first brace on the left in FIG. 2). This brace shape provides a middle section 14 of a constant height with end sections 15 wherein the height of the brace decreases constantly between the beginning of the end section 15 and the extremity of the brace. This particular shape has the advantage of offering an excellent weigh:rigidity ratio, as the height of the brace is greater toward the middle of the brace where bending is most likely to occur. Furthermore, a supporting brace 2 having this shape can be manufactured easily, given that the supporting brace 2 can simply be cut from a sheet of aluminum or other suitable material having a proper thickness, with minimal loss of material.

The final component of the rigidified window system 4 is the adhesive 3 used for bonding the at least one supporting brace 2 to the window 1. As previously mentioned, the selected adhesive 3 must offer high adhesive performance in order to ensure that the bond is maintained, even under the force of an impact, and to ensure that even after such an impact, the efficiency of the bond is not affected. The selected adhesive must additionally have a central section offering a predetermined elasticity to the bond in order to participate in the absorption of the forces being applied to the window 1, the adhesive 3 and the supporting brace 2, when an impact is produced by the contact of an object against the window system 4. This elasticity of the adhesive bond 3 should have a value of elongation at break of at least 100%, which means that the bond should be able to expand at least to twice its original thickness before breaking. Modified Silane Polymers (also known as MS polymers), such as the one commercialized by Loctite®, product number 5590, are the adhesives that were used in the development of the present invention, as they present all of the above-mentioned characteristics. More precisely, technical documentation reveals that Loctite's® 5590 MS Polymer has an elongation at break of 130%, while offering a tensile strength of 435 psi and a sheer strength on steel of 290 psi. However, one skilled in the art will understand that other adhesives could be used in the present invention, including structural silicone, polyurethane adhesives and other adhesive sealants or glues respecting the above-mentioned characteristics. The thickness of the bond can also be varied to ensure that the adhesive joint has the desired elasticity.

Preferably, the ratio between the weight and rigidity of said window system 4 will be optimized to provide increased protection at the minimum possible weight. This optimization can be made through simulations using finite element analysis software. The results obtained in these simulations must subsequently be validated with impact tests.

As previously mentioned, preferred embodiments of the present invention are particularly adapted for the rigidification of window systems 4 for transport vehicles. The above-mentioned transport vehicles can be any vehicle that is meant to transport passengers, whether by land, air or water. In a possible embodiment of the present invention, the at least one supporting brace 2 is used as a mean for affixing the window 1 to the frame of the transport vehicle. In this particular embodiment, if a plurality of supporting braces is present, it is possible to either use all of them, or only a selected portion, as affixing members for affixing the window 1 to the frame.

Additionally, the present invention presents a method of manufacturing the rigidified window system 4. The method involves providing a window 1, and bonding at least one supporting brace 2 to the surface of the window 1. This method further involves using an adhesive 3 offering a predetermined elasticity to bond the at least one supporting brace 2 to the window and selecting the quantity, shape, width 13, height 12, length 11 and material used to manufacture the at least one supporting brace 2 in order to allow a predetermined flexibility of the window 1 and supporting brace 2. This elasticity of the bond 3 and flexibility of the window 1 and at least one supporting brace 2 aims at providing increased absorption of the forces created by an impact with the sharing of the absorption between the window 1, the bond 3 and the at least one supporting brace 2.

The particularities of the characteristics of the window 1, the one or more supporting brace 2 and the adhesive 3 described hereinabove, in reference with the rigidified window system 4, all apply to the corresponding components used in the method of manufacture that is described herein, and need not be repeated.

Similarly, the present method of manufacturing the rigidified window system 4 is also particularly adapted for the lateral windows of transport vehicles. The at least one supporting brace 2 of the rigidified window system 4 created using the present method of manufacture, can once again be used as affixing means for affixing the window to the frame of the transport vehicle. Therefore the comments provided above concerning these matters may also be included in the description of the present method of manufacture.

While the present invention has been shown and described with reference to preferred embodiments thereof, it will be understood by one skilled in the art that various changes in form and detail may be made therein without departing from the scope or spirit of the present invention.

1. A rigidified window system comprising:
a window; and
at least one supporting brace;
wherein said at least one supporting brace is bonded to the surface of said window using an adhesive, said adhesive being selected and sized to offer a predetermined elasticity to the bond, and wherein the quantity, shape, width, height, length and to material used to manufacture said at least one supporting brace are selected to provide a predetermined flexibility of said window and said at least one supporting brace, and wherein said elasticity of the bond and said flexibility of said window and said at least one supporting brace provide absorption of the forces created by an impact, the absorption being shared between said window, bond and at least one supporting brace.

2. The rigidified window system according to claim 1, wherein said at least one supporting brace is shaped with a central section of constant height and two extremity sections wherein the height of said brace decreases constantly.

3. The rigidified window system according to claim 1, wherein the ratio between the weight and rigidity of said window system is optimized.

4. The rigidified window system according to claim 2, wherein the ratio between the weight and rigidity of said window system is optimized.

5. The rigidified window system according to claim 1, wherein said window is a lateral window of a transport vehicle.

6. The rigidified window system according to claim 2, wherein said window is a lateral window of a transport vehicle.

7. The rigidified window system according to claim 3, wherein said window is a lateral window of a transport vehicle.

8. The rigidified window system according to claim 4, wherein said window is a lateral window of a transport vehicle.

9. The rigidified window system according to claim 5, wherein said at least one supporting brace is used as anchor for affixing said window to the frame of said transport vehicle.

10. The rigidified window system according to claim 8, wherein said at least one supporting brace is used as anchor for affixing said window to the frame of said transport vehicle.

11. A method of manufacturing a rigidified window system comprising the steps of :
a) providing a window; and
b) bonding at least one supporting brace to the surface of said window;
wherein said at least one supporting brace is bonded to the surface of said window using an adhesive, said adhesive being selected and sized to offer a predetermined elasticity to the bond, and wherein the quantity, shape, width height, length and material used to manufacture said at least one supporting brace are selected to provide a predetermined flexibility of said window and said at least one supporting brace, and wherein said elasticity of the bond and said flexibility of said window and said at least one supporting brace provide absorption of the forces created by an impact, the absorption being shared between said window, bond and at least one supporting brace.

12. The method of manufacturing a rigidified window system according to claim 11, wherein said at least one supporting brace is shaped with a central section of constant height and two extremity sections wherein the height of said brace decreases constantly.

13. The method of manufacturing a rigidified window system according to claim 11, wherein the ratio between the weight and rigidity of said window system is optimized.

14. The method of manufacturing a rigidified window system according to claim 12, wherein the ratio between the weight and rigidity of said window system is optimized.

15. The method of manufacturing a rigidified window system according claims 11, wherein said window is a lateral window of a transport vehicle.

16. The method of manufacturing a rigidified window system according claims 12, wherein said window is a lateral window of a transport vehicle.

17. The method of manufacturing a rigidified window system according claims 13, wherein said window is a lateral window of a transport vehicle.

18. The method of manufacturing a rigidified window system according claims 14, wherein said window is a lateral window of a transport vehicle.

19. The method of manufacturing a rigidified window system according to claim 15, wherein said at least one supporting brace is used as anchor for affixing said window to a frame of said transport vehicle.

20. The method of manufacturing a rigidified window system according to claim 18, wherein said at least one supporting brace is used as anchor for affixing said window to a frame of said transport vehicle.
